(19) United States
(12) Patent Application Publication
(10) Pub. No.: US 2017/0243122 A1
(43) Pub. Date: Aug. 24, 2017

(54) ANALYSIS APPARATUS AND ANALYSIS SYSTEM

(71) Applicant: JTEKT CORPORATION, Osaka-shi (JP)

(72) Inventors: Hayato KOMATSU, Ama-gun (JP); Koichi Kato, Nagakute-shi (JP); Yoshiji Yamamoto, Toyohashi-shi (JP)

(73) Assignee: JTEKT CORPORATION, Osaka-shi (JP)

(21) Appl. No.: 15/440,685

(22) Filed: Feb. 23, 2017

(30) Foreign Application Priority Data
Feb. 24, 2016 (JP) 2016-033118
Dec. 27, 2016 (JP) 2016-254446

(51) Int. Cl. G06N 5/04; G05B 19/418

(52) U.S. Cl. CPC G06N 5/04; G05B 19/41875; G05B 2219/34291

(57) ABSTRACT

To provide an analysis apparatus capable of improving the accuracy of analysis results. An analysis apparatus makes predictions about the quality of conditions of a production facility or the quality of conditions of a production object in a process of producing a crankshaft as the production object by a grinder as the production facility. The analysis apparatus includes the plurality of predictors making predictions about the quality by using different analysis methods based on data concerning the production facility, a selection unit selecting the plurality of predictors in use from the plurality of predictors,
and an overall predictor calculating a comprehensive prediction result about the quality based on the plurality of prediction results obtained by the plurality of predictors in use selected by the selection unit.

### CROSS REFERENCE TO RELATED APPLICATIONS

This application claims priority based on Japanese Patent Application No. 2016-033118 filed on Feb. 24, 2016 and Japanese Patent Application No. 2016-254446 filed on Dec. 27, 2016, the entire contents of which are incorporated by reference herein.

### TECHNICAL FIELD

The present invention relates to an analysis apparatus and an analysis system.

### BACKGROUND ART

In Patent Literature 1, an analysis model deciding device which intends to improve the accuracy of analysis by deciding the optimum analysis model from among three analysis models is disclosed. The analysis model deciding device according to Patent Literature 1 includes a data analysis unit which applies learning data to the three analysis models to be learned, then, adopts evaluation data to each analysis model to measure a probability of default. After that, the data analysis unit compares respective measured results of the three analysis models and decides the analysis model with the highest accuracy as the optimum analysis model.

### LIST OF RELATED ART

### Patent Literature

[PATENT LITERATURE 1]: JP2002-109208A

### SUMMARY OF INVENTION

### Problems to be Solved by Invention

Here, there has been known an analysis apparatus which makes predictions about the quality of conditions of a production facility or the quality of conditions of a production object during production in a process of producing and processing the production object by the production facility. In such analysis apparatus, the prediction accuracy tends to vary according to environment in which the production facility is arranged or a use state of the production facility. Accordingly, the prediction accuracy of the analysis model determined by the measurement results based on prior learning may be lower than that of another analysis model. In this case, the accuracy of analysis results by the analysis apparatus is reduced.

An object of the present invention is to provide an analysis apparatus and an analysis system capable of improving the accuracy of analysis results.

### Means for Solving the Problems

An analysis apparatus according to the present invention which makes predictions about the quality of conditions of a production facility or the quality of conditions of a production object in a process of producing the production object by the production facility includes a plurality of predictors making predictions about the quality by using different analysis methods based on data concerning the production facility, a selection unit selecting the plurality of predictors in use from the plurality of predictors, an overall predictor calculating a comprehensive prediction result about the quality based on a plurality of prediction results obtained by the plurality of predictors in use and a prediction accuracy calculation unit calculating accuracies of predictions made by the respective plurality of predictors based on prediction results made by the respective plurality of predictors and inspection results about the quality, in which the selection unit selects the plurality of predictors in use from the plurality of predictors based on prediction accuracies calculated by the prediction accuracy calculation unit.

In the analysis apparatus according to the present invention, the selection unit selects a plurality of predictors in use from the plurality of predictors based on prediction accuracies and the overall predictor uses the plurality of predictors whereby high prediction accuracies can be obtained in the environment where the production facility is arranged and the use state of the production facility. The overall predictor calculates a comprehensive prediction result about the quality of conditions of the production facility or the quality of conditions of the production object based on the plurality of prediction results obtained by the plurality of predictors in use. Therefore, the analysis apparatus according to the present invention can improve the accuracy of analysis results.

The prediction accuracy calculation unit calculates accuracies of predictions made by the respective plurality of predictors based on prediction results made by the respective plurality of predictors and inspection results about the quality. Then, the selection unit selects predictors in use based on prediction accuracies calculated by the prediction accuracy calculation unit. Accordingly, the overall predictor can calculate a comprehensive prediction result based on the plurality of prediction results obtained by the plurality of predictors in use having high prediction accuracies. Therefore, the analysis apparatus according to the present invention can improve the accuracy of analysis results.

An analysis system according to the present invention includes a first analysis apparatus which is the above-described analysis apparatus and a second analysis apparatus which is connected to a network so as to perform data communication with the first analysis apparatus. The second analysis apparatus is set so as to make predictions about the quality by using auxiliary predictors not corresponding to predictors in use among the plurality of predictors and calculates the accuracies of predictions made by the auxiliary predictors. The selection unit replaces part of already selected predictors as predictors in use with auxiliary predictors having higher prediction accuracies based on the prediction accuracies of predictors in use calculated by the prediction accuracy calculation unit and prediction accuracies obtained from auxiliary predictors calculated in the second analysis apparatus.

In the analysis system according to the present invention, the second analysis apparatus makes predictions about the quality by the auxiliary predictors. If the first analysis apparatus makes predictions about the quality by all the plurality of predictors, it may take time to calculate prediction results by the predictors in use and to calculate the comprehensive prediction result. However, the time required for calculating the prediction results by the predictors in use and the comprehensive prediction result can be shortened by making predictions about the quality by the auxiliary predictors by the second analysis apparatus. It is preferable that the second analysis apparatus makes predictions about the quality by all auxiliary predictors and the first analysis apparatus does not make predictions about the quality by auxiliary predictors, or it is also preferable that the first analysis apparatus and the second analysis apparatus respectively make predictions about the quality by part of auxiliary predictors.

An analysis apparatus according to the present invention which makes predictions about the quality of conditions of a production facility or the quality of conditions of a production object in a process of producing the production object by the production facility includes the plurality of predictors making predictions about the quality by using different analysis methods based on data concerning the production facility and an overall predictor calculating a comprehensive prediction result about the quality based on the plurality of prediction results obtained by the plurality of predictors, in which the plurality of predictors include at least two or more predictors which make predictions by different analysis methods based on the same analysis target data obtained at the time of production processing by the production facility.

In the analysis apparatus according to the present invention, the overall predictor calculates a comprehensive result based on prediction results by at least two or more predictors making predictions with respect to the same analysis target data concerning the production facility by using different analysis methods. That is, multidimensional analysis can be made by utilizing the fact that prediction results are different according to analysis methods even when using the same analysis target data. Therefore, the analysis apparatus according to the present invention can improve the accuracy of analysis results.

### BRIEF DESCRIPTION OF THE DRAWINGS

FIG. 1 is a view showing a structure of a grinder using an analysis apparatus according to an embodiment of the present invention.

FIG. 2 is a block diagram showing a configuration of the analysis apparatus.

FIG. 3 is a table showing an example of a calculation method performed in an overall predictor.

FIG. 4 is a table showing an example of a calculation method performed in a prediction accuracy calculation unit.

FIG. 5 is a block diagram showing a configuration of an analysis system according to a second embodiment.

FIG. 6 is a block diagram showing a configuration of a second analysis apparatus.

### MODES FOR CARRYING OUT THE INVENTION

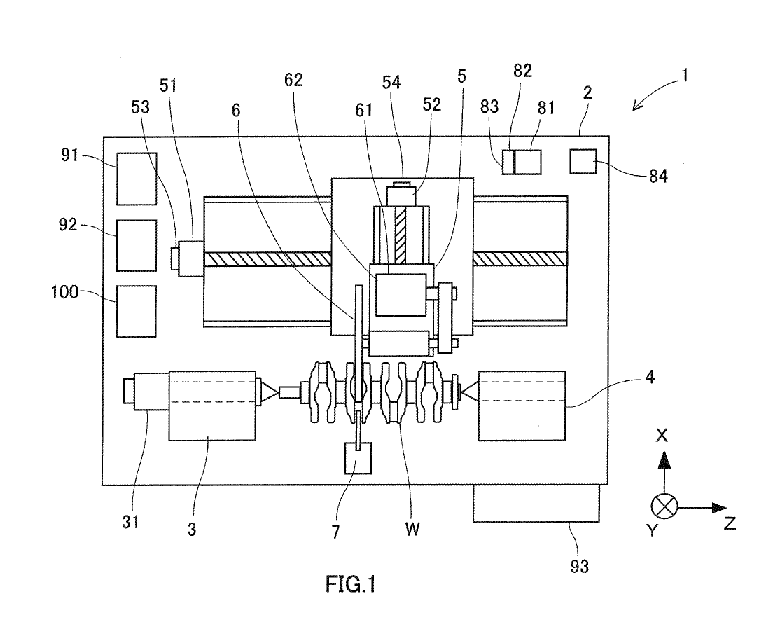

Hereinafter, an analysis apparatus according to embodiments of the present invention will be explained with reference to the drawings. Production facilities are facilities of producing given production objects. The production facilities include various facilities such as a machine tool, a conveying device and an industrial robot. The production facilities are, for example, a machine tool in charge of a machining process in a production line, which is a grinder for grinding a crankshaft, a conveyor for carrying in and carrying out from the machine tool and so on. In the embodiment, the production facility is, for example, the grinder. First, a grinder 1 as an example of the production facilities using an analysis apparatus 100 according to an embodiment of the present invention will be explained with reference to FIG. 1.

### 1. First Embodiment

### (1-1. Structure of Grinder 1)

As shown in FIG. 1, a grinder 1 is a grinding-wheel base traverse type grinder which performs grinding work to a crank journal, a crank pin and so on of a crankshaft W which is a production object. A bed 2 is fixed to an installation surface of the grinder 1, and a main spindle device 3 and a tailstock device 4 which rotatably support both ends of the crankshaft W are attached to the bed. The crankshaft W is supported by the main spindle device 3 and the tailstock device 4 so as to rotate around the crank journal. The main spindle device 3 includes a motor 31 which drives the crankshaft W to rotate.

Moreover, a grinding wheel base 5 is provided on the bed 2. The grinding wheel base 5 moves in a Z-axis direction (an axial direction of the crankshaft W) and an X-axis direction (a direction orthogonal to an axial line of the crankshaft W). The grinding wheel base 5 moves in the Z-axis direction by a motor 51 and moves in the X-axis direction by a motor 52. The grinding wheel base 5 is provided with two detectors 53, 54. The detector 53 detects a position of the grinding wheel base 5 in the Z-axis direction and the detector 54 detects a position of the grinding wheel base 5 in the X-axis direction. In the embodiment, rotary encoders which measure the rotation and so on of the motors 51, 52 are used as the detectors 53, 54, however, linear position detectors such as linear scales may be used as the detectors 53, 54.

The grinding wheel base 5 is provided with a grinding wheel 6 so as to rotate. The grinding wheel 6 is driven to be rotated by a motor 61, thereby grinding the crank pin or the crank journal. The grinding wheel base 5 is also provided with a detector 62 which detects electric current of the motor 61. Though an ammeter is used as the detector 62, a voltmeter, a wattmeter and so on which detect voltage and power of the motor 61 may be used as the detector 62. Furthermore, a sizing device 7 is provided in the bed 2. The sizing device 7 measures an external diameter of the crank pin or the crank journal as a grinding portion of the crank shaft W.

Additionally, a pump 81, a valve 82 and a detector 83 are provided in the bed 2. The pump 81 supplies a coolant to the grinding portion. The valve 82 switches between ON/OFF for supplying the coolant. The detector 83 detects a state of the valve 82. Although a flowmeter which detects a coolant flow rate is used as the detector 83 in the embodiment, a pressure gauge which detects a pressure of the coolant may be used as the detector 83. A detector 84 which detects an environmental temperature (outside air temperature) is further provided in the bed 2.

The grinder 1 further includes a CNC (Computerized Numerical Control) device 91, a PLC (Programmable Logic Controller) 92, a control panel 93 and the analysis apparatus 100. The CNC device 91 controls the motor 31 of the main spindle device 3, the motors 51, 52 of the grinding wheel base 5 and the motor 61 of the grinding wheel 6. The CNC device 91 acquires detection information from the detectors 53, 54 of the motors 51, 52 in the grinding wheel base 5 and the detector 62 of the motor 61 in the grinding wheel 6 at the time of performing control. The PLC 92 acquires detection information from the sizing device 7 as well as controls the supply of the coolant through the control of the pump 81 and the valve 82. The PLC 92 acquires detection information from the detector 83 of the valve 82 at the time of controlling the supply of the coolant. The PLC 92 acquires detection information about the environmental temperature from the detector 84.

The analysis apparatus 100 makes predictions about the quality of conditions of the production facility or the quality of conditions of the production object produced by the production facility. For example, the analysis apparatus 100 makes a prediction that the production object is a defective product due to occurrence of grinding burn in the production object. The analysis apparatus 100 also makes predictions about failures, lifespans, maintenance timing of respective components forming the production facility. In the embodiment, the analysis apparatus 100 makes predictions whether the crankshaft W is a good product or not in a process of performing grinding work to the crank journal, the crank pin and so on of the crankshaft W as the production object.

The analysis apparatus 100 will be explained as a separate apparatus from the CNC device 91 and the PLC 92, however, the analysis apparatus 100 may be an embedded system of the CNC device 91 or the PLC 92, which may be a personal computer or a server.

Also in the embodiment, the analysis apparatus 100 is provided in one grinder 1. The analysis apparatus 100 is also connected to respective detectors 53, 54, 62, 83, 84, the CNC device 91 and the PLC 92, which are provided in grinder 1, so as to perform data communication with them.

Here, one analysis apparatus 100 may be connected to a network so as to perform data communication with a plurality of production facilities such as a plurality of grinders 1. In this case, a network system (analysis system) including the analysis apparatus 100 and respective detectors 53, 54, 62, 83 and 84 can build an edge computing. The edge computing is a system connected to a network in a narrow region, which is a system capable of performing data processing at a place close to a generation source of data. The analysis apparatus 100 built by the edge computing can use a server (referred to as an edge server and so on) unifying the plurality of grinders 1.

The network system (analysis system) including the analysis apparatus 100 and respective detectors 53, 54, 62, 83 and 84 can also build a fog computing. The fog computing is a system connected to a network in a wider region as compared with the edge computing. The fog computing is installed, for example, in the same building or inside neighboring buildings (in a predetermined region).

The network system (analysis system) including the analysis apparatus 100 and respective detectors 53, 54, 62, 83 and 84 may also build a cloud computing which can be installed regardless of place. The cloud computing is a system which is connected to a network in a wider region as compared with the fog computing.

That is, a data transmission rate in a network building the fog computing is remarkably faster than a data transmission rate in a network building the cloud computing. Therefore, in the network building the fog computing, a large quantity of data can be transmitted in a short time as compared with the cloud computing. A data transmission rate in a network building the edge computing is further faster than the data transmission rate in the network building the fog computing. Therefore, in the network building the edge computing, a large quantity of data can be transmitted in a short time as compared with the fog computing.

Incidentally, the number of connected production facilities is smaller in the edge computing, the number is larger in the cloud computer and the number is in the middle of them in the fog computing. Accordingly, the edge computing is preferable when performing processing in real time, the cloud computing is preferable when processing many kinds of data, and the fog computing is preferable when processing many kinds of data while securing a certain degree of real time property.

### (1-2. Configuration of Analysis Apparatus 100)

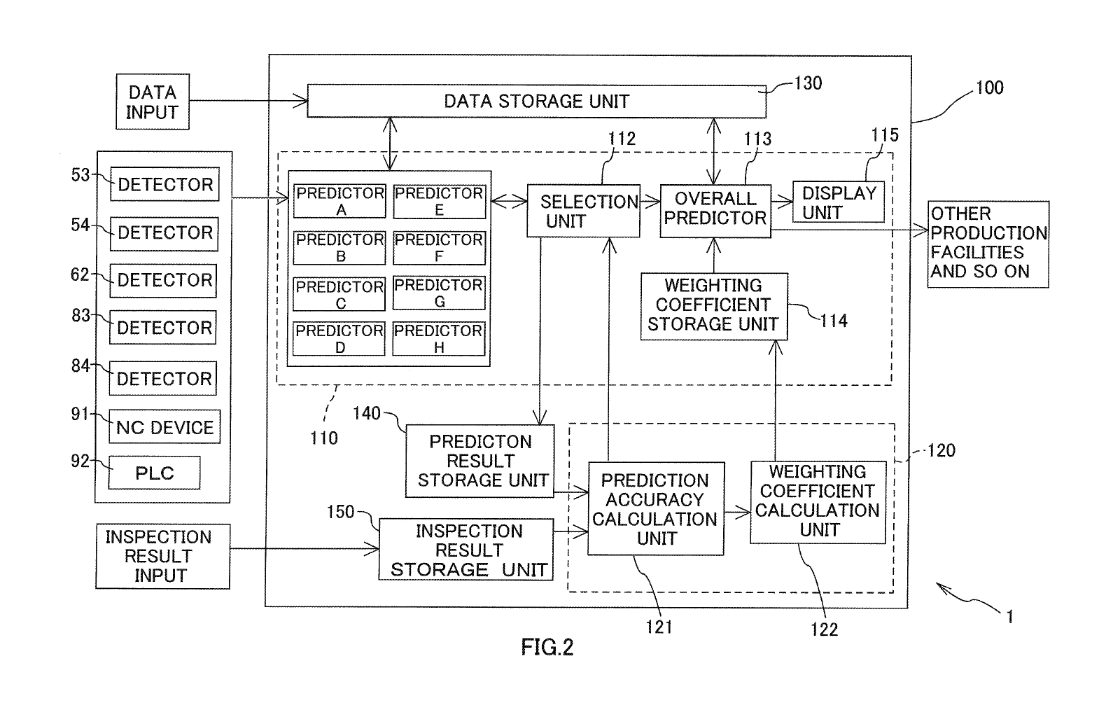

Next, a configuration of the analysis apparatus 100 will be explained with reference to FIG. 2. The analysis apparatus 100 is an apparatus analyzing whether the crankshaft W is a good product or not in the process of performing grinding work to the crank journal, the crank pin and so on of the crankshaft W (see FIG. 1) as the production object. The analysis apparatus 100 includes a prediction unit 110, a calculation unit 120, a data storage unit 130, a prediction result storage unit 140 and an inspection result storage unit 150.

The prediction unit 110 makes predictions about whether the crankshaft W to which grinding work is performed is a good product or not based on data obtained at the time of grinding work and various kinds of information and so on inputted in advance by an operator and so on. The calculation unit 120 checks a prediction result obtained by the prediction unit 110 with a result of inspection about whether the crankshaft W as the final product is a good product or not. Then, the calculation unit 120 feeds back the calculated result to the prediction unit 110.

The data storage unit 130 stores various kinds of information inputted by the operator and so on. As information stored in the data storage unit 130, parameters set as conditions and the like of the analysis apparatus 100 concerning later-described predictors A to H of the prediction unit 110 are cited, which are, for example, shapes and materials of the crankshaft W, shapes and materials of the grinding wheel 6, and grinding process information such as cut quantities of grinding and coolant flow rates. The parameters set in the predictors A to H are models for constructing analysis engines. The parameters are initially set based on data obtained from the detectors and results of production inspections about whether the crankshafts W are good products or not obtained at the time of performing grinding work of the crankshafts W by the grinder 1.

The prediction result storage unit 140 stores prediction results made by the later-described plurality of predictors A to H. The inspection result storage unit 150 stores results of production inspections about whether the crankshafts W to which grinding work is performed by the grinder 1 are good products or not. The data stored in the prediction result storage unit 140 and the inspection result storage unit 150 are used when the calculating unit 120 calculates prediction accuracies of respective predictors A to H.

### (1-2-1: Configuration of Prediction Unit 110)

As shown in FIG. 2, the prediction unit 110 mainly includes eight predictors A to H, a selection unit 112, an overall predictor 113, a weighting coefficient storage unit 114 and a display unit 115. The respective predictors A to H are analysis engines which make predictions about whether the crankshaft W is a good product or not by using analysis methods different from one another. The predictors A to H acquires data used for predictions by the respective predictors A to H from respective detectors 53, 54, 62, 83 and 84, the CNC device 91, the PLC 92 and the data storage unit 130 provided in the grinder 1. Then, the predictors A to H transmits data concerning prediction results made by the respective predictors A to H to the selection unit 112.

The selection unit 112 selects data concerning prediction results of part of predictors in use from data concerning prediction results received from the respective predictors A to H. Then, the selection unit 112 transmits the selected data to the overall predictor 113, and the overall predictor 113 calculates a comprehensive prediction result as the analysis apparatus 100. The selection unit 112 transmits all data concerning prediction results received from the respective predictors A to H to the prediction result storage unit 140. The selection unit 112 may transmit part of data concerning prediction results to the prediction result storage unit 140.

Here, examples of analysis engines used for the predictors A to H are cited in Table 1.

TABLE 1

| | | | |
|---|---|---|---|
| X-R control chart | Quantification IV class | Quantification I class | Dynamic Bayesian |
| | | | network |
| Principal component | Neural network | Quantification II class | Hidden Markov model |
| analysis | | | |
| Independent component | Support vector machine | Discriminant analysis | Simple Markov model |
| analysis | | | |
| Correlation analysis | Density ratio sequential | Conjoint analysis | Multiple Markov model |
| | estimation method | | |
| Distributive analysis | Specific spectrum | k-nearest neighboring | Petri net model |
| | method | method | |
| Factor analysis | Structural learning | Large margin nearest | Hybrid Petri net model |
| | method | neighboring method | |
| Multivariate control | Naive Bayes method | Gaussian process | Invariant distinction |
| chart | | regression | |
| Cumulative sum method | Decision tree | Ridge regression | Multilevel Petri net |
| | | | model |
| Moment method | MT method | Lasso regression | Interconnected Neural |
| | | | network |
| Hotelling T² method | k-means clustering | Bridge regression | Boltzmann Machines |
| T²-Q control chart | Fuzzy k-means | Adaptive Lasso | Recurrent neural |
| | clustering | regression | network |
| Survival analysis | Entropy method | Partial least square | Random forest |
| | | regression | |
| Test | Covariance structure | Space partial least | Linear adaptive control |
| | analysis method | squares regression | |
| Cluster analysis | Deep learning | Elastic net regression | Sequential identification |
| Self-organizing map | Multiple regression | Weighted directed graph | Mixed normal |
| | analysis | | distribution sequential |
| | | | update method |
| Quantification III class | Time series analysis | Arrow diagram | Quantitative factor |
| | | | quantitative analysis |
| | | | method |
| Multi dimensional | Logistic analysis | Bayesian network | |
| scaling | | | |

The analysis engines shown in Table 1 are classified so as to correspond to respective characteristics such as QC methods (for example, X-R control chart, correlation analysis and so on), linear adaptation (for example, linear adaptive control and so on), nonlinear identification (for example, sequential identification and so on), Bayesian methods (for example, a naive Bayes method, a Bayesian network and so on), machine learning (for example, a neural network, a support vector machine and so on) and regression analyses (for example, multiple regression analysis, ridge regression and so on). The prediction accuracy of each analysis engine varies according to a data amount to be analyzed (the number of data to be analyzed) or model accuracy. That is, in an analysis engine including many variables and constants of the models themselves such as statistics and an analysis engine including many prior probability distributions, the model accuracy becomes high and prediction accuracy is improved as the data amount to be analyzed becomes large.

For example, as the calculation amount is small and the relativity is clear in QC methods, the prediction accuracy can be improved even when the data amount to be analyzed is small. On the other hand, there is little prospect of improvement in prediction accuracy in the QC methods when the data amount to be analyzed is increased. In response to this, in Bayesian methods, the prediction comes close to prediction based on data from prediction based on prior information (prior probability and so on) as the data amount to be analyzed is increased, therefore, the prediction accuracy is improved. In machine learning, the prediction accuracy is improved as the data amount to be analyzed is increased. Similarly, in regression analysis, the prediction accuracy is improved as data to be analyzed is increased.

In linear adaptation, the accuracy of models themselves will be a factor for improving the prediction accuracy. The prediction accuracy in the linear adaptation can be improved in a stage where the data amount is small as compared with the QC method. In nonlinear identification, the accuracy of models themselves will be a factor for improving the prediction accuracy, however, it is difficult to construct models themselves.

According to the above aspects, the selection unit 112 selects the QC method or the linear adaptation when the data amount to be analyzed is relatively small and data obtained from detectors is small, thereby improving the prediction accuracy at an early stage. On the other hand, the selection unit 112 selects the regression analysis or the machine learning when the data amount to be analyzed is relatively large, thereby positively improving the prediction accuracy. Accordingly, the overall predictor 113 is preferably use different kinds of predictors by combining them from among the QC methods, the Bayesian methods, the linear adaptation, the regression analysis and the machine learning. That is, the overall predictor 113 uses analysis engines by combining analysis engines in which the prediction accuracy is increased when the data amount to be analyzed is small with analysis engines in which the prediction accuracy is increased when the data amount to be analyzed is large. Therefore, the overall predictor 113 can maintain a state where the prediction accuracy is high regardless of variation of the data amount while covering the case where the data amount to be analyzed which is acquired by respective detectors 53, 54, 62, 83, 84 and so on is small to the case where the data is large. Accordingly, the analysis apparatus 100 can increase the prediction accuracy.

In the machine learning, the regression analysis and so on, a plurality of engines in which variables, constants, accuracies of models themselves and so on are different may be used. Also in the machine learning, the regression analysis and so on, the analysis engine having the optimum variable, constant and accuracy of the model itself is used when the data amount to be analyzed is increased, thereby improving the prediction accuracy.

When selecting kinds of analysis engines to be installed in the analysis apparatus 100 as predictors, or when selecting kinds of predictors to be set as predictors in use from among all the predictors A to H by the selection unit 112, the selection unit 112 may set fixed conditions.

For example, all the predictors A to H may be analysis engines making predictions by analysis methods different from one another based on the same analysis target data (for example, current values of the motor 61 of the grinding wheel 6 (see FIG. 1)). In this case, the overall predictor 113 can made predictions about the quality of the crankshaft W by using different analysis methods with respect to the same analysis target data. That is, the overall predictor 113 can make multidimensional analysis by utilizing the fact that prediction results are different according to analysis methods even when using the same analysis target data. Accordingly, the analysis apparatus 100 can increase the accuracy of prediction results.

In addition to the above, only part of the predictors A to H may be analysis engines making predictions by analysis methods different from one another based on the same analysis target data. In this case, it is preferable that at least part of predictors in use are analysis engines making predictions by analysis methods different from one another based on the same analysis target data (for example, current values of the motor 61 of the grinding wheel 6 (see FIG. 1)). It is also preferable that all predictors in use may be analysis engines making predictions by analysis methods different from one another based on the same analysis target data (for example, current values of the motor 61 of the grinding wheel 6 (see FIG. 1)). Also in these cases, the analysis apparatus 100 can increase the accuracy of prediction results.

It is also preferable that at least part of the predictors A to H may be analysis engines making predictions based on different analysis target data (for example, data obtained from the detector 62 detecting current values of the motor 61 of the grinding wheel 6 (see FIG. 1), the detector 83 which detects coolant flow rates, the detectors 53, 54 which detect positions of the grinding wheel base 5). In particular, it is preferable that at least part of predictors in use corresponds to the analysis engines making predictions based on different analysis object data.

In this case, the analysis apparatus 100 can make comprehensive predictions by using data concerning prediction results using different analysis object data. That is, the prediction results can be obtained in consideration of various factors generated in the grinder 1 by using the different analysis object data. Therefore, the analysis apparatus 100 can increase the prediction accuracy.

It is also preferable that all predictors in used are analysis engines making predictions based on different analysis object data. In this case, the analysis apparatus 100 can increase the accuracy of prediction results. Then, all the predictors A to H may be analysis engines making predictions based on different analysis object data. In this case, all predictors in use can be analysis engines making predictions based on different analysis object data positively.

The weighting coefficient storage unit 114 stores weighting coefficients calculated by the calculation unit 120. The weighting coefficients are numerical values allocated to respective predictors in use based on the prediction accuracy of respective predictors in use. The overall predictor 113 calculates comprehensive prediction results based on data concerning prediction results of respective predictors in use received from the selection unit 112 and weighting coefficients acquired from the weighting coefficient storage unit 114. Then, the display unit 115 displays analysis results received from the overall predictor 113 to inform the operator of the results.

### (1-2-2: Configuration of Calculation Unit 120)

The calculation unit 120 includes a prediction accuracy calculation unit 121 and a weighting coefficient calculation unit 122. The prediction accuracy calculation unit 121 checks prediction results of respective predictors A to H received from the prediction unit 110 with inspection results concerning the quality of the crank shaft W. Then, the calculation unit 120 calculates accuracies of predictions made by the respective predictors A to H.

The prediction accuracy calculation unit 121 also extracts the plurality of predictors with high prediction accuracies (hereinafter referred to as “high-accuracy predictors”) from the plurality of predictors A to H based on the calculated prediction accuracies. Then, the prediction accuracy calculation unit 121 feeds back data concerning the extracted high-accuracy predictors to the prediction unit 110. The data fed back to the prediction unit 110 is used when the selection unit 112 determines whether already selected predictors in use is replaced with other predictors or not.

The weighting coefficient calculation unit 122 calculates weighting coefficients corresponding to prediction accuracies with respect to respective high-accuracy predictors extracted by the prediction accuracy calculation unit 121. Then, the weighting coefficient calculation unit 122 transmits data concerning the calculated weighting coefficients to the prediction unit 110. The data concerning the weighting coefficient transmitted to the prediction unit 110 is stored in the weighting coefficient storage unit 114.

### (1-2-3: Processing of Prediction Unit 110)

Next, processing executed by the prediction unit 110 will be explained. Here, explanation will be made by citing a case where respective predictors A to H analyze whether grinding burn occurs in the crankshaft W or not in the process of performing grinding work by the grinder 1, and the overall predictor 113 makes a prediction about whether the crankshaft W is a good product or not based on the analysis results.

The respective detectors 53, 54, 62, 83, 84, the CNC device 91 and the PLC 92 provided in the grinder 1 transmit data obtained in the process of performing grinding work of the crankshaft W by the grinder 1 to the predictors A to H.

The respective predictors A to H perform analyses based on data received from the grinder 1. Then, the respective predictors A to H calculate probabilities that the crankshaft W to which the grinding work is performed by the grinder 1 is a good product. At this time, the respective predictors A to H acquire data stored in the data storage unit 130 according to need, and perform analyses based on the acquired data. Data concerning the prediction results (good product probabilities of the crankshaft W) performed by the respective predictors A to H is transmitted to the selection unit 112.

When the selection unit 112 acquires data from the respective predictors A to H, the selection unit 112 determines whether the acquired data is data concerning prediction results by the predictors in use or not. Then, when the acquired data is data concerning prediction results by the predictors in use, the selection unit 112 transmits the data to the overall predictor 113. In the embodiment, three predictors with higher prediction accuracies are set as the predictors in use among eight predictors A to H provided in the analysis apparatus 100.

The selection unit 112 transmits all data acquired from the respective predictors A to H to the prediction result storage unit 140. The prediction result storage unit 140 stores data concerning prediction results by all the predictors A to H received from the selection unit 112.

When the overall predictor 113 receives all data concerning the prediction results made by the predictors in use, the overall predictor 113 calculates a comprehensive prediction result as the analysis apparatus 100. At this time, the overall predictor 113 acquires data concerning weighting coefficients from the weighting coefficient storage unit 114 and acquires data from the data storage unit 130. Then, the overall predictor 113 calculates the comprehensive prediction result based on these data.

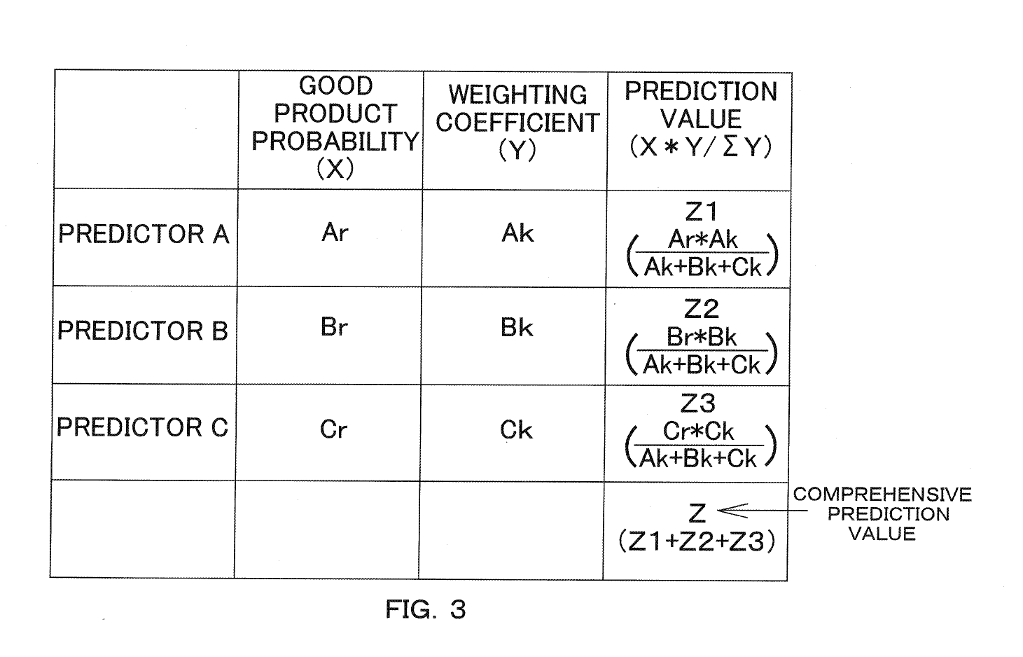

Here, an example of a method of calculating prediction results made by the overall predictor 113 will be explained with reference to FIG. 3. The explanation will be made on the assumption that three predictors A to C are set as the predictors in use among the plurality of predictors A to H in this case.

First, the overall predictor 113 calculates prediction values Z1 to Z3 of respective predictors A to C based on good product probabilities Ar to Cr as prediction results by the respective predictors A to C and weighting coefficients Ak to Ck stored in the weighting coefficient storage unit. The weighting coefficients Ak to Ck are indexes set so as to correspond to prediction accuracies of the three predictors in use. The prediction values Z1 to Z3 are numerical values obtained by dividing numerical values obtained by multiplying the good product probabilities Ar to Cr of the respective predictors A to C by the weighting coefficients Ak to Ck of the respective predictors A to C by a total value of the weighting coefficients Ak to Ck (Ak+Bk+Ck).

Next, the overall predictor 113 adds up the calculated prediction values Z1 to Z3 of the respective predictors A to C. The total numerical value corresponds to a comprehensive prediction value Z calculated as the analysis apparatus 100. When the comprehensive value Z satisfies a predetermined level, the overall predictor 113 determines that the crankshaft W is a good product. On the other hand, when the comprehensive prediction value Z does not satisfy the predetermined level, the comprehensive predictor 113 determined that the crankshaft W is a defective product.

The overall predictor 113 may multiply the good product probabilities Ar to Cr by values obtained by adjusting the weighting coefficients Ak to Ck when calculating respective prediction values Z1 to Z3. For example, there is a case where data which can have a bad influence on accuracies of predictions made by respective predictors in use among data acquired from the grinder 1 or the data storage unit 130 (for example, data concerning outside air environment, data concerning use states of production facilities and so on). In this case, the overall predictor 113 may perform adjustment to the weighting coefficients Ak to Ck so that numerical values of weighting coefficients of predictors in use which can have a bad influence on the prediction accuracies are relatively reduced.

As in the above case, the overall predictor 113 calculates the comprehensive prediction result based on data concerning environment in which the grinder 1 is arranged, data concerning use states of production facilities and so on. Therefore, data concerning outside air environment or data concerning use states of production facilities can be incorporated into the comprehensive prediction result calculated by the overall predictor 113. Accordingly, the analysis apparatus 100 can improve the accuracy of analysis results.

Returning to FIG. 2, the explanation is continued. The overall predictor 113 transmits the calculated comprehensive prediction result to the display unit 115 and other production facilities. As other production facilities, a conveyor for conveying the crankshafts W to which grinding work by the grinder 1 is finished, production facilities used in production processes performed after grinding work by the grinder 1 and so on can be cited. In this case, for example, when receiving a determination result indicating that the crankshaft W is a defective product, the crankshaft Wdetermined as the defective product can be removed from a production line. Accordingly, it is possible to avoid processing from being performed to the crankshaft W as the defective product in production processes after the grinding work by the grinder 1, therefore, the grinder 1 can reduce manufacturing costs.

The display unit 115 displays determination results received from the overall predictor 113. The operator can confirm the determination results displayed on the display unit 115. For example, in the case where the operator determined that there are more defective products than usual (appearance probability of defective products in which grinding burn occurs is high) as a result of confirming analysis results by the analysis apparatus 100, the operator can perform maintenance of the grinder 1 at that time. As described above, the operator can find an abnormality or a sign of an abnormality of the grinder 1 in production processes of the crankshaft W. Therefore, the operator can respond to the abnormality of the grinder 1 at an early stage as compared with a case where the operator find an abnormality or a sign of an abnormality of the grinder 1 based on inspection results of product inspections with respect to the crankshaft W. As a result, the grinder 1 suppresses the number of defective products to be produced. Although the display unit 115 is provided in the grinder 1 in the embodiment, a monitor and so on provided in other places may be used as the display unit 115.

Note that the analysis apparatus 100 performs analyses at a place close to the grinder 1. Accordingly, the operator can decide a reference value for determining whether the crankshaft W is a good product or not while checking states of the crankshaft W as a production object and the grinder 1. Furthermore, when a sudden abnormality occurs in the grinder 1 or the crankshaft W, the operator can analyze data immediately in cooperation with the analysis apparatus 100. Then, the operator can also immediately incorporate the analysis result into determination information for the analysis apparatus 100. In the abnormality determination or in a previous stage of the abnormality determination (not in an abnormal state but close to the abnormal state), the production facility such as the grinder 1 or the analysis apparatus 100 can inform the operator of the abnormal state or stop operation of the production facility automatically based on analysis results of the analysis apparatus 100. The analysis apparatus 100 can perform analysis in a state of being connected to the grinder 1 through a network.

### (1-2-4: Processing of Calculation Unit 120)

Next, processing executed by the calculation unit 120 will be explained. The processing by the calculation unit 120 is performed at a stage where a certain amount of data is accumulated in the prediction result storage unit 140 and the inspection result storage unit 150.

The prediction accuracy calculation unit 121 acquires data concerning prediction results of the respective predictors A to H stored in the prediction result storage unit 140 and inspection results stored in the inspection result storage unit 150. Then, the prediction accuracy calculation unit 121 calculates prediction values indicating prediction accuracies of the respective predictors A to H by checking the prediction results of the respective predictors A to H with the inspection results.

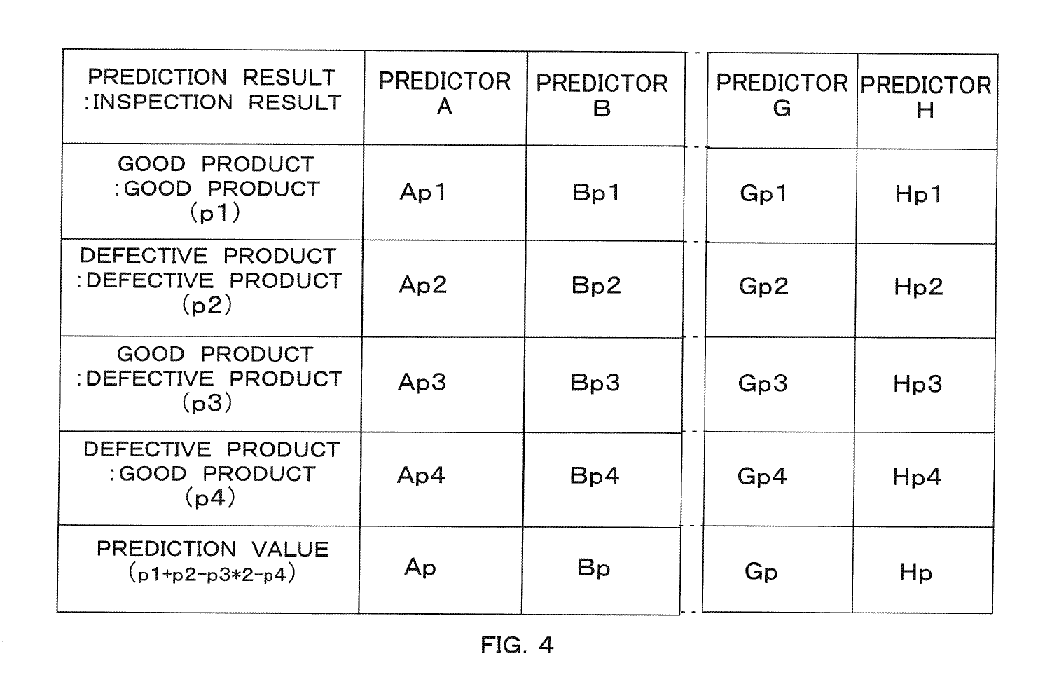

Here, an example of a method of calculating prediction accuracies of the respective predictors A to H performed by the prediction accuracy calculation unit 121 will be explained with reference to FIG. 4. As shown in FIG. 4, the prediction accuracy calculation unit 121 first checks prediction results with respect to the crankshafts W performed by the respective predictors A to H with inspection results. A numerical value obtained by dividing the number of crankshafts W (pa1) determined as good products both in prediction results and inspection results by the total number (all) of the crankshafts W to which prediction and inspection have been performed is represented by p1(=pa1/all). A numerical value obtained by dividing the number of crankshafts W (pa2) determined as defective products both in prediction results and inspection results by the total number (all) of the crankshafts W to which prediction and inspection have been performed is represented by p2(=pa2/all).

A numerical value obtained by dividing the number of crankshafts W (pa3) determined as good products in prediction results and determined as defective products in inspection results by the total number (all) of the crankshafts W to which prediction and inspection have been performed is represented by p3(pa3/all). A numerical value obtained by dividing the number of crankshafts W (pa4) determined as defective products in prediction results and determined as good products in inspection results by the total number (all) of the crankshafts W to which prediction and inspection have been performed is represented by p4(pa4/all). The prediction accuracy calculation unit 121 calculates numerical values p1 to p4 for respective predictors A to H. For example, a numerical value p1 of the predictor A is Ap1.

Next, the prediction accuracy calculation unit 121 calculates prediction values of respective predictors A to H based on the numerical values p1 to p4 calculated with respect to the respective predictors A to H. In the embodiment, the prediction accuracy calculation unit 121 sets a numerical value obtained by subtracting the double of p3, and p4 from the total of the numbers of crankshafts W in which prediction results correspond to inspection results as a prediction value.

That is, the prediction accuracy calculation unit 121 performs evaluation so that the prediction accuracy becomes high when prediction results correspond to inspection results and performs evaluation so that the prediction accuracy becomes low when prediction results do not correspond to inspection results.

Furthermore, the prediction accuracies Ap to Hp are calculated by changing weights of numerical values p3 and p4 which are prediction errors. That is, the prediction accuracy calculation unit 121 performs weighting so that the influence on prediction values differs in the numerical value p3 obtained when the crankshaft W determined as the defective product in the inspection result is predicted as the good product and the numerical value p4 obtained when the crankshaft W determined as the good product in the inspection result is predicted as the defective product at the time of calculating prediction values.

In the case corresponding to the numerical value p3, that is, when the crankshaft W is determined as the good product in the analysis result by the analysis apparatus 100 though the crankshaft W is actually the defective product, the grinder 1 performs production processing performed after the grinding work is finished with respect to the crankshaft W as the defective product. In this case, the post-process will be in vain. That is, in the case corresponding to the numerical value p3, loss of production time is large. Accordingly, the prediction accuracy is calculated by the calculation method in which the prediction value is largely reduced in the case of the numerical value p3 in the embodiment.

On the other hand, in the case corresponding to the numerical value p4, that is, when the crankshaft W is determined as the defective product in the analysis result by the analysis apparatus 100 though the crankshaft W is actually the good product, the crankshaft W is thrown away after the grinding work by the grinder 1 is finished. In this case, loss on production time is smaller than the case corresponding to the numerical value p3. Accordingly, the influence on the prediction value is reduced in the case of the numerical value p4 as compared with the numerical value p3. As described above, the overall predictor 113 can reduce the case where production objects as defective products are wrongly predicted as good products by changing the degree of influence on the case of prediction errors. As a result, the grinder 1 can reduce the loss occurring when performing production processing with respect to defective products, which can reduce manufacturing costs.

In the embodiment, the prediction accuracy calculation unit 121 doubles the value p3, however, it is possible to set a value larger than “1” as a value multiplied by “p3” according to the reliability of the production objects. In this case, as the prediction accuracy calculation unit 121 sets the value multiplied by “p3” to a larger value, the analysis apparatus 100 can increase the reliability of prediction by the overall predictor 113 (reduce the case where production objects as defective products are wrongly predicted as good products).

The prediction accuracy calculation unit 121 compares prediction values of the respective predictors A to H after prediction values of all the predictors A to H are calculated. Then, the prediction accuracy calculation unit 121 extracts three predictors having higher prediction values as high-accuracy predictors from among all the predictors A to H. The prediction accuracy calculation unit 121 transmits data concerning the extracted three high-accuracy predictors to the selection unit 112 of the prediction unit 110 and the weighting coefficient calculation unit 122.

The selection unit 112 executes replacement processing in which predictors with low prediction accuracies among predictors set as predictors in use are replaced with high-accuracy predictors which are not set as predictors in use based on data received from the prediction accuracy calculation unit 121 according to need. That is, there is a case where the prediction accuracy of the predictor set as the predictor in use is reduced due to variation of states of the grinder 1 or variation of environment in which the grinder 1 is placed. In such case, the selection unit 112 updates the setting of predictors selected as predictors in use, and replaces one predictor with a reduced prediction accuracy with another predictor with a high prediction accuracy. Accordingly, the selection unit 112 can select predictors with high prediction accuracies as predictors in use from among the plurality of predictors A to H. Therefore, the analysis apparatus 100 can improve the accuracy of analysis results.

As described above, the selection unit 112 selects part of predictors based on the prediction accuracies calculated by the prediction accuracy calculation unit 121. Therefore, the prediction results obtained by the predictors with high prediction accuracies are transmitted to the overall predictor 113, therefore, the analysis apparatus 100 can improve the accuracy of the comprehensive prediction results calculated by the overall predictor 113.

When the weighting coefficient calculation unit 122 receives data concerning prediction values of the three high-accuracy predictors from the prediction accuracy calculation unit 121, the weighting coefficient calculation unit 122 calculates weighting coefficients corresponding to prediction values of respective high-accuracy predictors. Then, the weighting coefficient calculation unit 122 transmits data concerning the calculated weighting coefficients with respect to the three high-accuracy predictors to the weighting coefficient storage unit 114 of the prediction unit 110. The weighting coefficient storage unit 114 stores data received from the weighting coefficient calculation unit 122. As described above, the overall predictor 113 calculates the comprehensive prediction result after performing weighting so as to correspond to prediction accuracies of respective predictors in use when calculating the comprehensive prediction result based on prediction results obtained from predictors in use. In this case, the overall predictor 113 can incorporate prediction accuracies of respective predictors in use when calculating the comprehensive prediction result. Therefore, the analysis apparatus 100 can improve the accuracy of analysis results.

As described above, the prediction accuracy calculation unit 121 calculates prediction results of the plurality of predictors A to H based on prediction results and inspection results performed by the respective plurality of predictors A to H. The selection unit 112 selects predictors to be set as predictors in use based on prediction accuracies of the plurality of predictors A to H, and the overall predictor 113 calculates the comprehensive prediction result based on the prediction results by predictors with high prediction accuracies. Therefore, the analysis apparatus 100 can improve the accuracy of analysis results.

As grinding work is performed to many crankshaft W by the grinder 1, much data obtained from the detectors and results of product inspections about whether the crankshafts W are good products or not are accumulated. In this case, the analysis apparatus 100 may set parameters of the predictors A to H again. Accordingly, the respective predictors A to H can increase prediction accuracies.

### 2. Second Embodiment

Next, a second embodiment will be explained. In the first embodiment, the case where all the predictors A to H provided in the prediction unit 110 makes predictions, and the selection unit 112 transmits data concerning prediction results of the predictors in use to the overall predictor 113 has been explained. On the other hand, a case where analysis by at least part of predictors other than predictors in use is performed by a second analysis apparatus 400 in the second embodiment. An example in which analysis by all predictors other than predictors in use is performed by the second analysis apparatus 400 is cited below. The same numerals are given to the same components as the above embodiment and the explanation thereof is omitted.

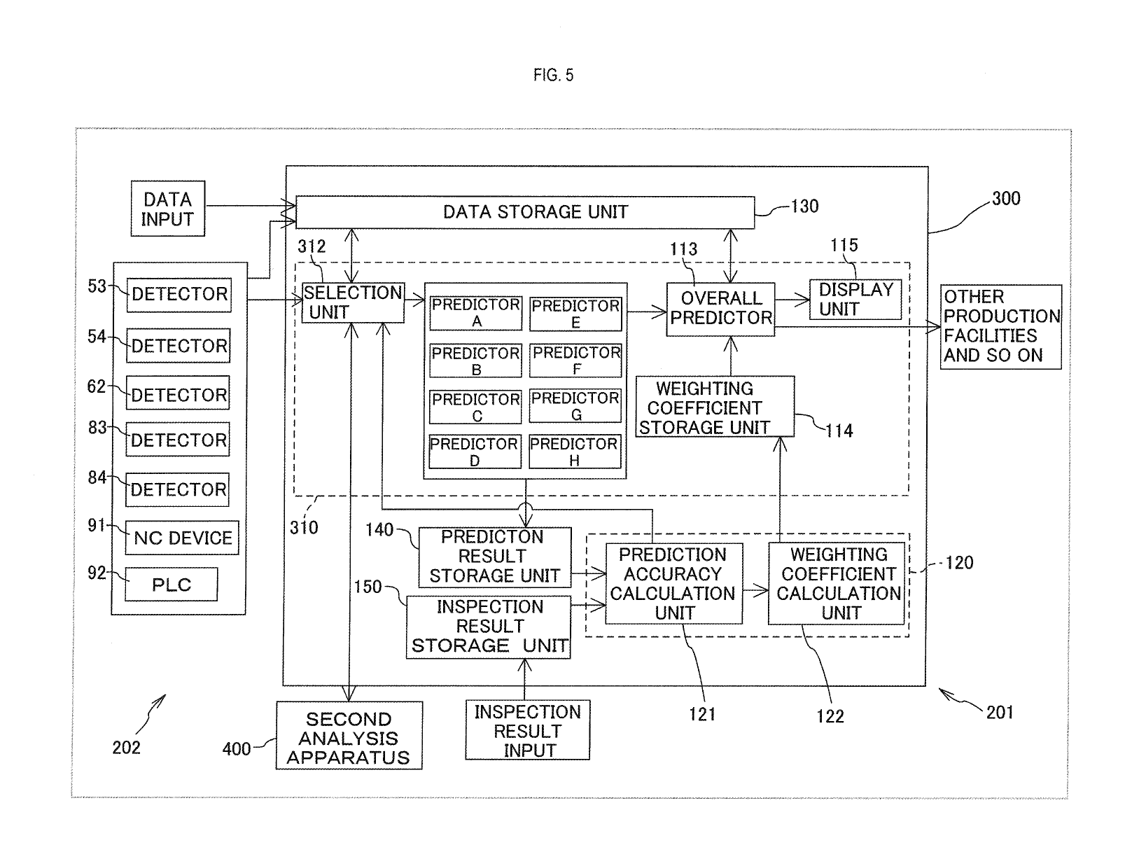

As shown in FIG. 5, an analysis system 202 includes a first analysis apparatus 300 and the second analysis apparatus 400. The first analysis apparatus 300 and the second analysis apparatus 400 are connected to a network so as to perform data communication through a transmission path (not shown). For example, the first analysis apparatus 300 and the second analysis apparatus 400 are installed in the same building or neighboring buildings (in a predetermined region) to build the fog computing. Additionally, the first analysis apparatus 300 and the second analysis apparatus 400 may build the cloud computing which can be installed regardless of place. The first analysis apparatus 300 and the second analysis apparatus 400 may naturally build the edge computing.

The first analysis apparatus 300 includes a prediction unit 310, the calculation unit 120, the data storage unit 130, the prediction result storage unit 140 and the inspection result storage unit 150. The prediction unit 310 mainly includes eight predictors A to H, a selection unit 312, the overall predictor 113, the weighting coefficient storage unit 114 and the display unit 115.

The selection unit 312 acquires data used for analysis by predictors in use from respective detectors 53, 54, 62, 83 and 84, the CNC device 91, the PLC 92 and the data storage unit 130 provided in a grinder 201 and transmits the data to the predictors in use. Then, the predictors in use transmits data concerning prediction results to the overall predictor 113. The predictors in use also transmit data concerning prediction results to the prediction result storage unit 140, and the prediction result storage unit 140 stores data concerning prediction results of the predictors in use. Then, the calculation unit 120 checks prediction results obtained by predictors in use with results of inspection performed about whether the crankshafts W are good products or not, and feeds back the calculated results to the prediction unit 110.

The selection unit 312 acquires data used for prediction by predictors not corresponding to predictors in use among eight predictors (hereinafter referred to as “auxiliary predictors”) from the respective detectors 53, 54, 62, 83 and 84, the CNC device 91, the PLC 92 and the data storage unit 130 provided in the grinder 201 and transmits the data to the second analysis apparatus 400.

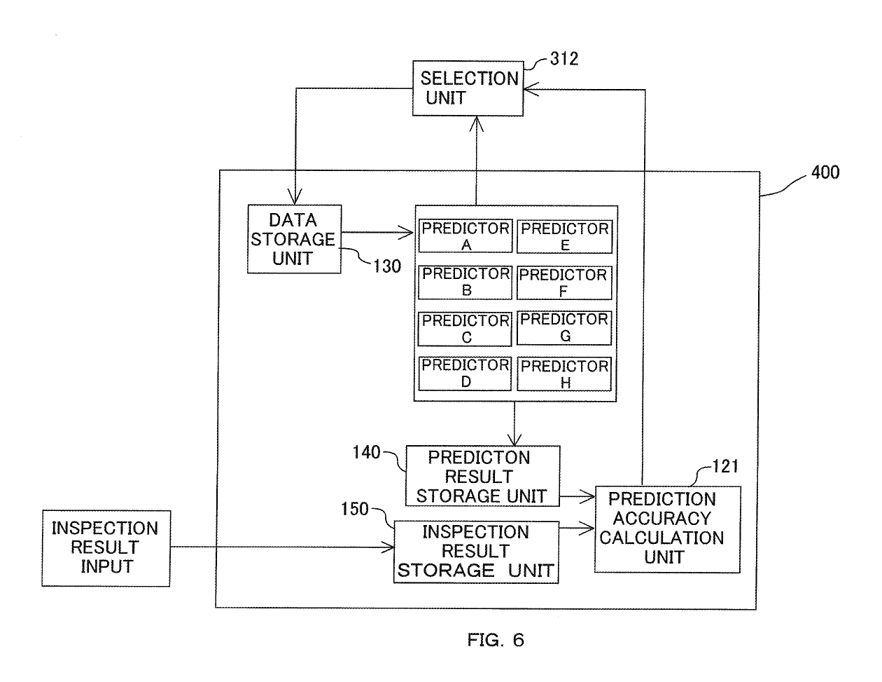

As shown in FIG. 6, the second analysis apparatus 400 makes predictions by the auxiliary predictors and checks prediction results obtained by the auxiliary predictors with results of inspection performed about whether the crankshafts W are good products or not. The second analysis apparatus 400 mainly includes eight predictors A to H, the data storage unit 130, the prediction result storage unit 140, the inspection result storage unit 150 and the prediction accuracy calculation unit 121.

The second analysis apparatus 400 stores data received from the selection unit 312 in the data storage unit 130. Then, the auxiliary predictors makes predictions based on data stored in the data storage unit 130 and transmits calculation results by the prediction accuracy calculation unit 121 to the selection unit 312. The selection unit 312 executes replacement processing in which predictors with low prediction accuracies among predictors set as predictors in use are replaced with high-accuracy predictors which are not set as predictors in use based on data received from the second analysis apparatus 400 according to need. Accordingly, the selection unit 312 can select predictors with high prediction accuracies among the plurality of predictors A to H as predictors to be set as predictors in use. Therefore, the analysis apparatus 100 can improve the accuracy of analysis results.

In the analysis system 202, the first analysis apparatus 300 makes predictions by predictors in use among eight predictors A to H. Then, the second analysis apparatus 400 predicts the quality by the auxiliary predictors. If the first analysis apparatus 300 makes predictions about the quality by all the plurality of predictors, it may take time to calculate prediction results by the predictors in use and to calculate the comprehensive prediction result.

However, the time required for calculating the prediction results by the predictors in use and the comprehensive prediction result can be shortened by making predictions about the quality by the auxiliary predictors by the second analysis apparatus 400. It is preferable that the second analysis apparatus 400 makes predictions about the quality by all auxiliary predictors and the first analysis apparatus 300 does not make predictions about the quality by auxiliary predictors, or it is also preferable that the first analysis apparatus and the second analysis apparatus respectively make predictions about the quality by part of auxiliary predictors.

In the analysis system 202, the selection unit 312 may select the order of making predictions with respect to the second apparatus 400 based on predetermined conditions. For example, the selection unit 312 may instruct the second analysis apparatus 400 to preferentially perform analysis by predictors with higher prediction values or to perform analysis by predictors in which the number of times of analysis execution is small among the auxiliary predictors.

When analysis by predictors with high prediction values are preferentially made, the second analysis apparatus 400 preferentially make predictions by predictors which are highly likely to be replaced with predictors in use. Accordingly, the selection unit 312 can select predictors A to H with higher prediction accuracies as predictors in use, therefore, the first analysis apparatus 300 can increase the accuracy of prediction made by the overall predictor 113. When predictions are made by predictors in which the number of times of analysis execution is small, the second analysis apparatus 400 can evenly perform analysis with respect to respective auxiliary predictors. As a result, the analysis system 202 can grasp accurate prediction values with respect to all the predictors A to H.

As grinding work is performed to many crankshaft W by the grinder 1, much data obtained from the detectors and results of product inspections performed about whether the crankshafts W are good products or not are accumulated. In this case, the second analysis apparatus 400 may set parameters of the plurality of predictors A to H again. Accordingly, the first analysis apparatus 300 and the second analysis apparatus 400 can increase prediction accuracies performed by the plurality of respective predictors A to H.

The first analysis apparatus 300 and the second analysis apparatus 400 can transmit and receive data of any of prediction models of the predictors A to H between both apparatuses. In this case, the first analysis apparatus 300 and the second analysis apparatus 400 can respectively set parameters and so on again. Then, the operator can confirm parameters and so on in the first analysis apparatus 300 or the second analysis apparatus 400. Furthermore, an external personal computer and so on can be connected to the first analysis apparatus 300, and the parameters and data of prediction models of the predictors A to H of the first analysis apparatus 300 can be transmitted and received between the first analysis apparatus 300 and the external personal computer. In this case, the external personal computer can set parameters and so on again. Then, the operator can confirm the parameters and so on by the external personal computer.

### 3. Others

The present invention has been explained based on the above embodiments, however, the present invention is not limited to the above embodiments and it is obvious that various alterations and modifications may occur within a scope not departing from the gist of the present invention.

For example, explanation has been made in the above embodiments by citing the grinder 1 as an example of the production facility using the analysis apparatus 100, which performs grinding work to the crank journal, the crank pin and so on of the crankshaft W in the production process for producing the crankshaft Was the production object. However, the present invention is not limited to this, and the analysis apparatus 100 may be used for production facilities for producing other production objects such as EPS and ITCC. In this case, the analysis apparatus 100 can set predictors with high prediction accuracies as predictors in use among the plurality of predictors A to H according to production objects or production facilities. Therefore, the analysis apparatus 100 can obtain analysis results with high prediction accuracies when used for various production facilities.

Also in the above embodiments, the case where the analysis apparatus 100 is used for the grinding-wheel base traverse type grinder traversing the grinding wheel base 5 in the Z-axis direction with respect to the bed 2 has been explained. However, the present invention is not limited to this, and the analysis apparatus 100 may be used for a table-traverse type grinder traversing the main spindle device 3 with respect to the bed 2 in the Z-axis direction.

Although the case where predictors in use designated by the selection unit 112 are set based on prediction values calculated by the prediction accuracy calculation unit 121 has been explained in the embodiment, the operator may arbitrarily set predictors in use. The selection of predictors to be set as predictors in use in the initial state in which prediction results by the plurality of predictors A to H and inspection results are not sufficiently accumulated may be arbitrarily performed by the operator and may be automatically performed based on test data stored in advance in the data storage unit 130 and so on.

Although the case where the selection unit 112 selects three predictors from among the plurality of predictors A to H as predictors in use has been explained in the above embodiments, the present invention is not limited to this. That is, two or less as well as four or more predictors may be used. The predictor 110 may change the number of predictors in use in accordance with the result of prediction values obtained from the calculation unit 120. In this case, the prediction unit 110 may select all the plurality of predictors as predictors in use.

### 4. Advantages

As described above, the analysis apparatuses 100 and 300 make predictions about the quality of conditions of the grinders 1 and 201 or the quality of production objects in the process of producing the crankshaft W as the production object by the grinders 1 and 201 as the production facilities. The analysis apparatuses 100 and 300 each include a plurality of predictors A to H making predictions about the quality by using different analysis methods based on data concerning the production facility, the selection units 112 and 312 selecting the plurality of predictors in use from the plurality of predictors A to H, the overall predictor 113 calculating the comprehensive prediction result concerning the quality based on the plural of prediction results obtained by the plurality of predictors in use and the prediction accuracy calculation unit 121 calculating accuracies of predictions made by the respective plurality of predictors A to H based on prediction results made by the respective plurality of predictors A to H and inspection results concerning the quality. Additionally, the selection units 112 and 312 select a plurality of predictor in use from the plurality of predictors A to H based on prediction accuracies calculated by the prediction accuracy calculation unit 121.

According to the analysis apparatuses 100 and 300, the selection units 112 and 312 select the plurality of predictors in use from the plurality of predictors A to H based on prediction accuracies, and the overall predictor uses the plurality of predictors whereby high prediction accuracies can be obtained in the environment in which the production facility is arranged and the use state of the production facility. Then, the overall predictor 113 calculates the comprehensive prediction result concerning the quality of conditions of the production facility or the equality of conditions of the production object based on the plurality of prediction results obtained from the plurality of predictors in use. Therefore, the analysis apparatuses 100 and 300 can improve the accuracy of analysis results as compared with the case where the prediction is made about whether the production object during production is a good product or not by making determination based on a fixed preset threshold. The analysis apparatuses 100 and 300 can have the same advantage also concerning the quality of conditions of production facilities.

The prediction accuracy calculation unit 121 calculates accuracies of predictions made by the respective plurality of predictors A to H based on prediction results made by the respective plurality of predictors A to H and inspection results concerning the quality, and the selection unit 112 and 312 select the plurality of predictors in use based on the prediction accuracies calculated by the prediction accuracy calculation unit 121. Therefore, the overall predictor 113 can calculate the comprehensive prediction result based on the plurality of prediction results obtained from the plurality of predictors in use having high prediction accuracies. Accordingly, the analysis apparatuses 100 and 300 can improve the accuracy of analysis results.

In the above analysis apparatuses 100 and 300, the prediction accuracy calculation unit 121 transmits data concerning prediction accuracies to the selection units 112 and 312, and the selection units 112 and 312 select part of predictors from the plurality of predictors A to H as the plurality of predictors in use and replaces already selected part of predictors with other predictors having higher prediction accuracies than the part of predictors based on data received from the prediction accuracy calculation unit 121.

According to the analysis apparatuses 100 and 300, the selection units 112 and 312 can select part of predictors having higher prediction accuracies from the plurality of predictors A to H as the plurality of predictors in use. Therefore, the analysis apparatuses 100 and 300 can improve analysis accuracies.

In the above analysis apparatuses 100 and 300, the plurality of predictors in use include at least two or more predictors which make predictions by different analysis methods based on the same analysis object data obtained at the time of production processing by the production facility. According to the analysis apparatuses 100 and 300, the overall predictor 113 calculates the comprehensive prediction result based on prediction results by at least two or more predictors making predictions by different analysis methods with respect to the same analysis object data obtained by the production processing by the production facility. That is, multidimensional analysis can be made by utilizing the fact that prediction results are different according to analysis methods even when using the same analysis object data. Accordingly, the analysis apparatuses 100 and 300 can improve the accuracy of analysis results.

In the above analysis apparatuses 100 and 300, the plurality of predictors in use include at least two or more predictors which make predictions based on different analysis object data obtained at the time of production processing by the production facility. The analysis apparatus 100 calculates the comprehensive analysis result based on prediction results of at least two or more predictors which make predictions based on different analysis object data obtained at the time of production processing by the production facility. That is, analysis results can be obtained in consideration of various factors occurring in the production facilities by using different analysis object data. Accordingly, the analysis apparatuses 100 and 300 can improve the accuracy of analysis results.

In the above analysis apparatuses 100 and 300, the overall predictor 113 calculates the comprehensive prediction result by performing weighting to the plurality of prediction results obtained from the plurality of predictors in use in accordance with prediction accuracies calculated by the prediction accuracy calculation unit 121. The analysis apparatus 100 can incorporate each prediction accuracy of each predictor at the time of calculating the comprehensive prediction result by the overall predictor 113. Accordingly, the analysis apparatuses 100 and 300 can improve the accuracy of analysis results.

The analysis apparatuses 100 and 300 according to the present invention are analysis apparatuses making predictions about the quality of the production object in the process of producing the crankshaft W as the production object by the grinder 1 as the production facility, including the plurality of predictors A to H making predictions about the quality of the production object by using different analysis methods based on data concerning the production facility and the overall predictor 113 calculating the comprehensive prediction result about the quality of the production object based on the plurality of prediction results obtained from the plurality of predictors A to H, in which the plurality of predictors A to H include at least two or more predictors making predictions by different analysis methods based on the same analysis object data obtained at the time of production processing by the production facility.

According to the analysis apparatuses 100 and 300, the overall predictor 113 calculates the comprehensive result with respect to the same analysis object data obtained at the time of production processing by the production facility based on prediction results of at least two or more predictors which make predictions by different analysis methods. Accordingly, the analysis apparatuses 100 and 300 can improve the accuracy of analysis results.

The above analysis apparatuses 100 and 300 include the prediction accuracy calculation unit 121 calculating accuracies of predictions made by the plurality of predictors A to H based on prediction results made by the respective the plurality of predictors A to H and inspection results about the quality of the production object, and the overall predictor 113 calculates the comprehensive prediction result after performing weighting to the prediction results of the plurality of predictors A to H in accordance with prediction accuracies calculated by the prediction accuracy calculation unit 121.

The above analysis apparatuses 100 and 300 can incorporate each prediction accuracy of each predictor at the time of calculating the comprehensive prediction result by the overall predictor 113. Accordingly, the analysis apparatuses 100 and 300 can improve the accuracy of analysis results.

In the above analysis apparatuses 100 and 300, the prediction accuracy calculation unit 121 performs weighting so as to largely reduce the prediction accuracy when a production object determined as a good product in the prediction result is determined as a defective product in the inspection result as compared with a case where a production object determined as a defective product in the prediction result is determined as a good product in the inspection result at the time of calculating prediction accuracies of the respective plurality of predictors A to H.

The analysis apparatuses 100 and 300 can suppress a production object as a defective product from being wrongly predicted as a good product. That is, in the case where the product is determined as the good product in the analysis result by the analysis apparatuses 100 and 300 through the product is actually a defective product, the production facility performs production processing performed after grinding work is finished with respect to the defective product. In this case, loss will be increased as compared with a case where a product which is an actually a good product is determined as a defective product in the analysis result by the analysis apparatuses 100 and 300 and removed from the production line. That is, the analysis apparatus 100 can reduce the loss caused by performing production processing to the defective product by suppressing the production object as the defective product from being wrongly predicted as the good product, therefore, manufacturing costs can be reduced.

Furthermore, the above analysis apparatuses 100 and 300 set parameters again used for predictions by the respective plurality of predictors A to H based on a newly acquired data concerning the production facility. The analysis apparatuses 100 and 300 can increase prediction accuracies performed by the respective plurality of predictors A to H.

In the above analysis apparatuses 100 and 300, the overall predictor 113 calculates the comprehensive prediction result based on data concerning environment (outside air and so on) in which the grinders 1 and 201 as the production facilities are arranged or data concerning use states of the production facilities. According to the analysis apparatuses 100 and 300, data concerning outside air environment or data concerning the use states of the production facilities can be incorporated into the comprehensive prediction result calculated by the overall predictor 113. Therefore, the analysis apparatuses 100 and 300 can improved accuracies of analysis results.

The analysis system 202 having the above analysis apparatus includes the first analysis apparatus 300 and the second analysis apparatus 400 which is connected to a network so as to perform data communication with the first analysis apparatus 300. The second analysis apparatus 400 is set so as to make predictions about the quality by using auxiliary predictors not corresponding to predictors in use among the plurality of predictors A to H and calculates the prediction accuracies made by the auxiliary predictors. The selection unit 312 replaces the already selected predictors as predictors in use with auxiliary predictors having higher prediction accuracies based on prediction accuracies of predictors in use calculated by the prediction accuracy calculation unit 121 and prediction accuracies obtained from auxiliary predictors calculated in the second analysis apparatus 400.

In the above analysis system 202, the second analysis apparatus 400 makes predictions about the quality by auxiliary predictors. If the first analysis apparatus 300 makes predictions about the quality by all the plurality of predictor A to H, it may take time to calculate prediction results by the predictors in use and to calculate the comprehensive prediction result. However, the time required for calculating the prediction results by the predictors in use and the comprehensive prediction result can be shortened by making predictions about the quality by the auxiliary predictors by the second analysis apparatus 400. It is preferable that the second analysis apparatus 400 makes predictions about the quality by all auxiliary predictors and the first analysis apparatus 300 does not make predictions about the quality by auxiliary predictors, or it is also preferable that the first analysis apparatus and the second analysis apparatus respectively make predictions about the quality by part of auxiliary predictors.

In the above analysis system 202, the second analysis apparatus 400 includes the plurality of auxiliary predictors. The analysis system 202 determines predictors preferentially making predictions among the plurality of auxiliary predictors based on predetermined conditions by the second analysis apparatus 400. The analysis apparatus 202 can make predictions efficiently by the plurality of auxiliary predictors in the second analysis apparatus 400.

Furthermore, the analysis system 202 sets parameters used for predictions by the respective plurality of predictors A to H provided in the first analysis apparatus 300 and the second analysis apparatus 400 again based on newly acquired data concerning the production facilities. According to the analysis system 202, the first analysis apparatus 300 and the second analysis apparatus 400 can increase accuracies of predictions performed by the respective plurality of predictors A to H.

1. An analysis apparatus making predictions about the quality of conditions of a production facility or the quality of conditions of a production object in a process of producing the production object by the production facility, comprising:
a plurality of predictors making predictions about the quality by using different analysis methods based on data concerning the production facility;
a selection unit selecting the plurality of predictors in use from the plurality of predictors;
an overall predictor calculating a comprehensive prediction result about the quality based on a plurality of prediction results obtained by the plurality of predictors in use; and
a prediction accuracy calculation unit calculating accuracies of predictions made by the respective plurality of predictors based on prediction results made by the respective plurality of predictors and inspection results about the quality,
wherein the selection unit selects the plurality of predictors in use from the plurality of predictors based on prediction accuracies calculated by the prediction accuracy calculation unit.

2. The analysis apparatus according to claim 1,
wherein the prediction accuracy calculation unit transmits data concerning the prediction accuracies to the selection unit, and
the selection unit selects part of predictors from the plurality of predictors as the plurality of predictors in use, and replaces the already selected part of predictors with other predictors having higher prediction accuracies than the part of predictors based on data received from the prediction accuracy calculation unit.

3. The analysis apparatus according to claim 1,
wherein the plurality of predictors in use include at least two or more predictors which make predictions by different analysis methods based on the same analysis object data concerning the production facility.

4. The analysis apparatus according to claim 1,
wherein the plurality of predictors in use include at least two or more predictors which make predictions based on different analysis object data concerning the production facility.

5. The analysis apparatus according to claim 1,
wherein the overall predictor calculates a comprehensive prediction result after performing weighting to the plurality of prediction results obtained from the plurality of predictors in use in accordance with the prediction accuracies calculated by the prediction accuracy calculation unit.

6. The analysis apparatus according to claim 1,
wherein the analysis apparatus sets parameters used for predictions by the respective plurality of predictors again based on newly acquired data concerning the production facility.

7. The analysis apparatus according to claim 1,
wherein the overall predictor calculates a comprehensive prediction result based on data concerning environment in which the production facility is arranged or data concerning a use state of the production facility.

8. The analysis apparatus according to claim 7,
wherein the prediction accuracy calculation unit performs weighting so as to largely reduce the prediction accuracy when a production object determined as a good product in the prediction result is determined as a defective product in the inspection result at the time of calculating prediction accuracies of the respective plurality of predictors as compared with a case where a production object determined as a defective product in the prediction result is determined as a good product in the inspection result.

9. The analysis apparatus according to claim 8,
wherein the analysis apparatus sets parameters used for predictions by the respective plurality of predictors again based on newly acquired data concerning the production facility.

10. The analysis apparatus according to claim 8,
wherein the overall predictor calculates a comprehensive prediction result based on data concerning environment in which the production facility is arranged or data concerning a use state of the production facility.

11. An analysis apparatus making predictions about the quality of conditions of a production facility or the quality of conditions of a production object in a process of producing the production object by the production facility, comprising:
a plurality of predictors making predictions about the quality by using different analysis methods based on data concerning the production facility; and
an overall predictor calculating a comprehensive prediction result about the quality based on a plurality of prediction results obtained by the plurality of predictors,
wherein the plurality of predictors include at least two or more predictors which make predictions by different analysis methods based on the same analysis object data concerning the production facility.

12. The analysis apparatus according to claim 11, further comprising:
a prediction accuracy calculation unit calculating accuracies of predictions made by the respective plurality of predictors based on prediction results made by the respective plurality of predictors and inspection results about the quality,
wherein the overall predictor calculates a comprehensive prediction result after performing weighting to the plurality of prediction results by the plurality of predictors in accordance with the prediction accuracies calculated by the prediction accuracy calculation unit.

13. The analysis apparatus according to claim 12,
wherein the prediction accuracy calculation unit performs weighting so as to largely reduce the prediction accuracy when a production object determined as a good product in the prediction result is determined as a defective product in the inspection result at the time of calculating prediction accuracies of the respective plurality of predictors as compared with a case where a production object determined as a defective product in the prediction result is determined as a good product in the inspection result.

14. The analysis apparatus according to claim 12,
wherein the analysis apparatus sets parameters used for predictions by the respective plurality of predictors again based on newly acquired data concerning the production facility.

15. The analysis apparatus according to claim 11,
wherein the overall predictor calculates a comprehensive prediction result based on data concerning environment in which the production facility is arranged or data concerning a use state of the production facility.

16. An analysis system comprising:
a first analysis apparatus which is the analysis apparatus according to claim 1; and
a second analysis apparatus which is connected to a network so as to perform data communication with the first analysis apparatus,
wherein the second analysis apparatus is set so as to make predictions about the quality by using auxiliary predictors not corresponding to predictors in use among the plurality of predictors and calculates the accuracies of predictions made by the auxiliary predictors, and
the selection unit replaces part of already selected predictors as predictors in use with auxiliary predictors having higher prediction accuracies based on the prediction accuracies of predictors in use calculated by the prediction accuracy calculation unit and prediction accuracies obtained from auxiliary predictors calculated in the second analysis apparatus.

17. The analysis system according to claim 16,
wherein the second analysis apparatus includes the plurality of auxiliary predictors, and
the analysis system determines predictors preferentially making predictions among the plurality of auxiliary predictors based on predetermined conditions by the second analysis apparatus.

18. The analysis system according to claim 16,
wherein the analysis system sets parameters used for predictions by the respective plurality of predictors provided in the first analysis apparatus and the second analysis apparatus again based on newly acquired data concerning the production facility.
